(19) United States
(12) Patent Application Publication
(10) Pub. No.: US 2024/0219414 A1
(43) Pub. Date: Jul. 4, 2024

(54) MATERIAL TESTING SYSTEMS WITH DATA IMPORTATION WORFKLOW PROGRESSION

(71) Applicant: Illinois Tool Works Inc., Glenview, IL (US)

(72) Inventors: Jason Morse, Grafton, MA (US); Scott Nicol, Acton, MA (US); Daniel Vincent Caesar, South Boston, MA (US)

(21) Appl. No.: 18/514,276

(22) Filed: Nov. 20, 2023

Related U.S. Application Data
(60) Provisional application No. 63/435,606, filed on Dec. 28, 2022.

(51) Int. Cl. G01N 35/00

(52) U.S. Cl. CPC G01N 35/00732; G01N 2035/00752; G01N 2035/0091

(57) ABSTRACT

Described herein are examples of material testing systems that allow operators to use data importation devices to automatically import data into input fields of a graphical user interface (GUI) associated with a material testing workflow. Such automatic importation helps to avoid potential errors in manual entry. Additionally, the material testing system allows operators to advance the material testing workflow (and/or GUI) from one state to another, thereby reducing the need (and/or time needed) for an operator to switch back and forth between the data importation device(s) and a separate input device.

### CROSS REFERENCE TO RELATED APPLICATIONS

This application claims the priority to, and the benefit of, U.S. Provisional Patent Application No. 63/435,606, filed Dec. 28, 2022, entitled “Material Testing Systems with Data Importation Workflow Progression,” the entire contents of which are hereby incorporated by reference.

### TECHNICAL FIELD

The present disclosure generally relates to material testing systems and, more particularly, to material testing systems with data importation workflow progression.

### BACKGROUND

Material testing machines are used to test the properties (e.g., tensile/compressive strength) of various material specimens. The particular method of testing (a.k.a. test method) may vary from material specimen to material specimen. A computing device in communication with the material testing machine may guide a user through a workflow to setup, execute, and analyze the results of each test method.

Limitations and disadvantages of conventional and traditional approaches will become apparent to one of skill in the art, through comparison of such systems with the present disclosure as set forth in the remainder of the present application with reference to the drawings.

### BRIEF SUMMARY

The present disclosure is directed to material testing systems with data importation workflow progression, substantially as illustrated by and/or described in connection with at least one of the figures, and as set forth more completely in the claims.

These and other advantages, aspects and novel features of the present disclosure, as well as details of an illustrated example thereof, will be more fully understood from the following description and drawings.

### BRIEF DESCRIPTION OF THE DRAWINGS

FIG. 1 shows an example material testing system, in accordance with aspects of this disclosure.

FIG. 2 is a block diagram of the material testing system of FIG. 1, in accordance with aspects of this disclosure.

FIG. 3 is a flow diagram illustrating an example state progression of a material testing workflow, in accordance with aspects of this disclosure.

FIG. 4 is a flowchart illustrating example operation of a workflow progression process, in accordance with aspects of this disclosure.

FIGS. 5a-5c show examples of different states of a graphical user interface associated with the material testing workflow of FIG. 3, in accordance with aspects of this disclosure

The figures are not necessarily to scale. Where appropriate, the same or similar reference numerals are used in the figures to refer to similar or identical elements. For example, reference numerals utilizing lettering (e.g., grip 124a, grip 124b) refer to instances of the same reference numeral that does not have the lettering (e.g., grips 124).

### DETAILED DESCRIPTION

Material testing workflows sometimes require an operator to enter several pieces of information to setup a test method for execution, analyze results of the test method, and/or report the results of the test method. However, manual entry of information relevant to the test method risks both data entry errors and delay. While some systems automatically import the information, it can be inconvenient for operators to switch between a data importation device (e.g., tag reader) and a separate input device (e.g., touch screen) to select the correct input field, move the information to the correct input field, and/or select to advance the workflow.

The disclosed example material testing systems use data importation devices to both automatically import data, and advance (or progress) the state of the material testing workflow. The automatic importation of data helps to reduce data entry errors that can occur during manual data entry. The workflow progression reduces the need (and/or time needed) for an operator to switch back and forth between the data importation device and a separate input device to advance the workflow.

Some examples of the present disclosure relate to a material testing system, comprising: a data importation device, the data importation device comprising a camera, a tag reader, or a measurement device; a material testing machine, comprising: a test sensor, a test actuator, and a test controller configured to control the test actuator; a display screen; and a computing device configured for communication with the display screen, the material testing machine, and the data importation device, the computing device comprising: processing circuitry configured to: initiate a material testing workflow configured to guide a user through setup, execution, or analysis of a test method of the material testing machine, display, on the display screen, a first graphical user interface (GUI) associated with a first state of the material testing workflow, the first GUI comprising one or more input fields, in response to receiving final field input data from the data importation device while a final input field of the one or more input fields has a focus for input: populate the final input field using the final field input data, and advance the focus for input away from the one or more input fields, and in response to receiving subsequent input data from the data importation device after the one or more input fields are populated on the display screen and the focus for input has been advanced away from the one or more input fields: advance the material testing workflow from the first state to a second state, and display, on the display screen, a second GUI associated with the second state of the material testing workflow.

In some examples, the processing circuity of the computing device is further configured to control the controller of the material testing machine to execute the test method using the final field input data. In some examples, the tag reader comprises a barcode reader, a near field communication (NFC) tag reader, a radio frequency identification (RFID) tag reader, or a short range ultra-high radio frequency tag reader. In some examples, the measurement device comprises a digital caliper.

In some examples, the first GUI further comprises guidance regarding how to use the data importation device to obtain the final field input data or subsequent input data. In some examples, the processing circuitry is further configured to: validate that the final field input data meets an input criterion, and prevent population of the final input field, advancement of the focus for input, or execution of the test method if the final field input data does not meet the test criterion. In some examples, validating that the final field input data meets the input criterion comprises validating that the final field input data is representative of an identifier of a fixture that complies with a test configuration of the test method.

Some examples of the present disclosure relate to a method, comprising: initiating, via processing circuitry of a computing device, a material testing workflow configured to guide a user through setup, execution, or analysis of a test method of a material testing machine in communication with the computing device, the material testing machine comprising a test sensor, a test actuator, and a test controller configured to control the test actuator; displaying, on a display screen in communication with the computing device, a first graphical user interface (GUI) associated with a first state of the material testing workflow, the first GUI comprising one or more input fields; receiving, at the computing device, final field input data from a data importation device while a final field input field of the one or more input fields has a focus for input, the data importation device comprising a camera, a tag reader, or a measurement device; in response to receiving, at the computing device, the final field input data from the data importation device while the final input field of the one or more input fields has the focus for input: populating the final input field using the final field input data, and advancing the focus for input away from the one or more input fields; and in response to receiving subsequent input data at the computing device, from the data importation device, after the one or more input fields are populated on the display screen and the focus for input has been advanced away from the one or more input fields: advancing the material testing workflow from the first state to a second state, and displaying, on the display screen, a second GUI associated with the second state of the material testing workflow.

In some examples, the method further comprises controlling, by the processing circuitry of the computing device, the controller of the material testing machine to execute the test method using the final field input data. In some examples, the tag reader comprises a barcode reader, a near field communication (NFC) tag reader, a radio frequency identification (RFID) tag reader, or a short range ultra-high radio frequency tag reader. In some examples, the measurement device comprises a digital caliper.

In some examples, the first GUI further comprises guidance regarding how to use the data importation device to obtain the final field input data or subsequent input data. In some examples, the method further comprises validating, by the processing circuitry, that the final field input data meets an input criterion; and preventing population of the final input field, advancement of the focus for input, or execution of the test method if the final field input data does not meet the test criterion. In some examples, validating that the final field input data meets the input criterion comprises validating that the final field input data is representative of an identifier of a fixture that complies with a test configuration of the test method.

Some examples of the present disclosure relate to a non-transitory computer readable medium comprising machine readable instructions which, when executed by a processor, cause the processor to: initiate a material testing workflow configured to guide a user through setup, execution, or analysis of a test method of a material testing machine, the material testing machine comprising a test sensor, a test actuator, and a test controller configured to control the test actuator; display, on a display screen, a first graphical user interface (GUI) associated with a first state of the material testing workflow, the first GUI comprising one or more input fields; receive final field input data from a data importation device while a final field input field of the one or more input fields has a focus for input, the data importation device comprising a camera, a tag reader, or a measurement device; in response to receiving the final field input data from the data importation device while the final input field of the one or more input fields has the focus for input: populate the final input field using the final field input data, and advance the focus for input away from the one or more input fields; and in response to receiving subsequent input data at the computing device, from the data importation device, after the one or more input fields are populated on the display screen and the focus for input has been advanced away from the one or more input fields: advance the material testing workflow from the first state to a second state, and display, on the display screen, a second GUI associated with the second state of the material testing workflow.

In some examples, the non-transitory computer readable medium further comprises machine readable instructions which, when executed by a processor, cause the processor to: control the controller of the material testing machine to execute the test method using the final field input data. In some examples, the tag reader comprises a barcode reader, a near field communication (NFC) tag reader, a radio frequency identification (RFID) tag reader, or a short range ultra-high radio frequency tag reader, and wherein the measurement device comprises a digital caliper. In some examples, the first GUI further comprises guidance regarding how to use the data importation device to obtain the final field input data or subsequent input data.

In some examples, the non-transitory computer readable medium further comprises machine readable instructions which, when executed by a processor, cause the processor to: validate that the final field input data meets an input criterion; and prevent population of the final input field, advancement of the focus for input, or execution of the test method if the final field input data does not meet the test criterion. In some examples, validating that the final field input data meets the input criterion comprises validating that the final field input data is representative of an identifier of a fixture that complies with a test configuration of the test method.

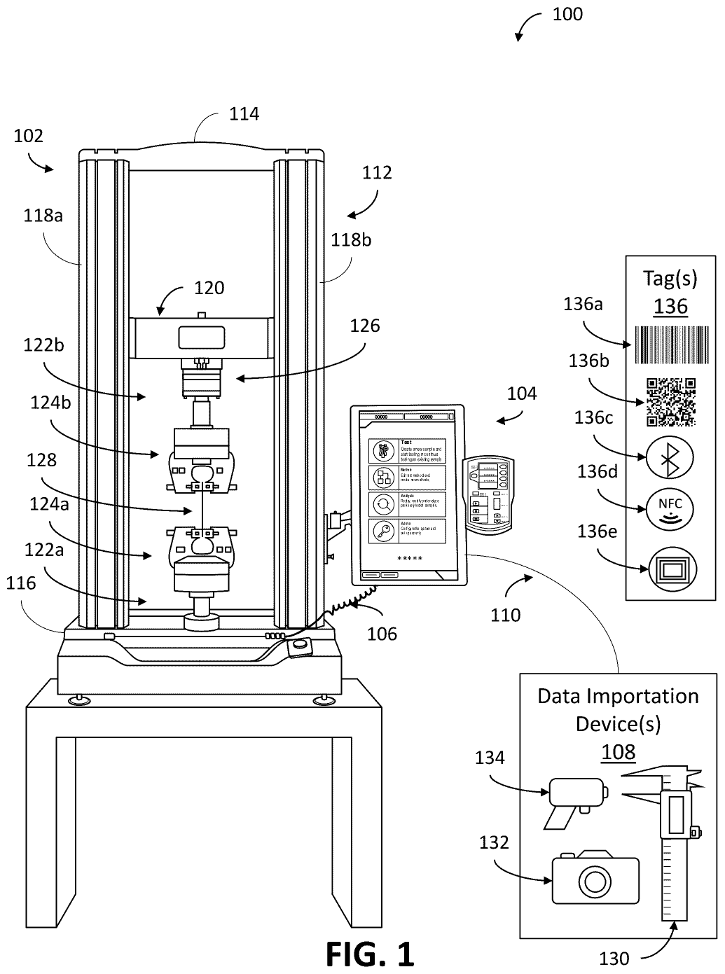

FIG. 1 shows an example material testing system 100. As shown, the material testing system 100 includes a material testing machine 102 (also known as a universal testing machine), a computing system 104 connected to the material testing machine 102 through cable 106, and one or more data importation devices 108 connected to the computing system 104 through cord 110. While shown as being physically connected, in some examples, the connections between the computing system 104, material testing machine 102, and/or data importation device 108 may be wireless rather than wired.

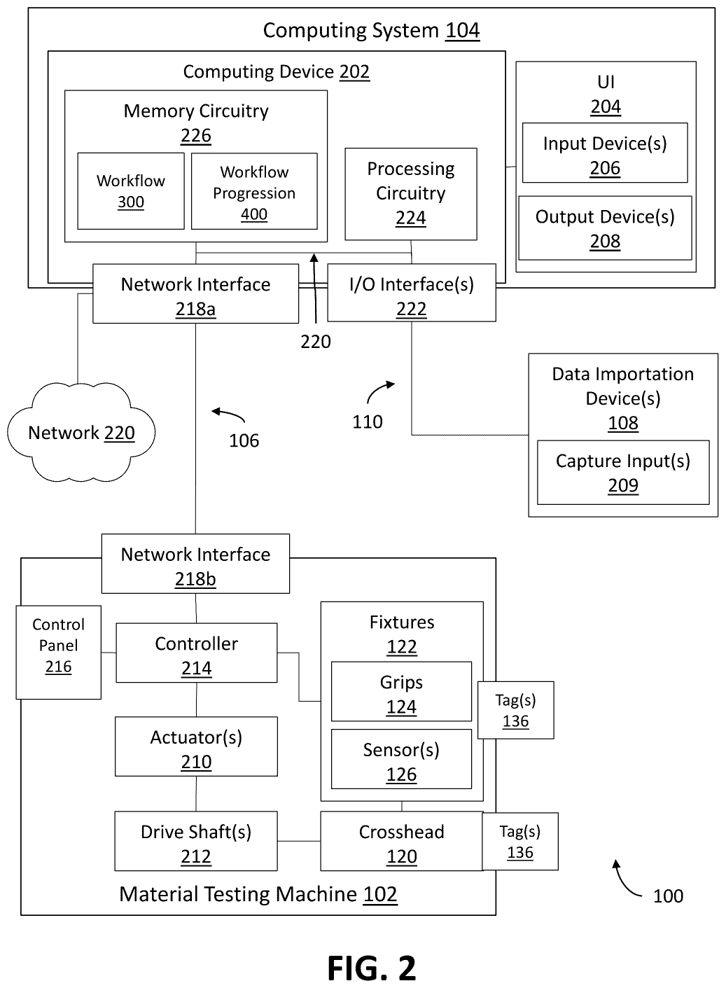

In the example of FIG. 1, the material testing machine 102 includes a frame 112. In some examples, the frame 112 provides rigid structural support for the other components of the material testing machine 102. As shown, the frame 112 comprises a top plate 114 and a bottom base 116 connected by two columns 118. In some examples, the columns 118 of the frame 112 may house guide rails and/or drive shafts 212 of the material testing machine 102 (see, e.g., FIG. 2).

In the example of FIG. 1, a movable crosshead 120 extends between the columns 118. In some examples, the movable crosshead 120 may be connected to the guide rails and/or drive shafts 212 housed in the columns 118, and/or configured to move toward and/or away from the base 116 through (e.g., motorized) actuation of the drive shaft(s) 212. While one movable crosshead 120 is shown in the example of FIG. 1, in some examples, the material testing machine 102 may have multiple movable crossheads 120, and/or other movable members.

In the example of FIG. 1, a fixture 122 is attached to the bottom base 116 of the frame 112, as well as to the movable crosshead 120. As shown, the lower fixture 122a includes a grip 124a, while the upper fixture 122b includes both a test sensor 126 and a grip 124b. While one test sensor 126 and two grips 124 are shown in the example of FIG. 1, in some examples, the testing machine 102 may include more or fewer test sensors 126 and/or grips 124.

In the example of FIG. 1, the grips 124 are holding a test specimen 128. While shown as a (e.g., steel) rope, in some examples, the test specimen 128 may be some other type of material and/or component. While shown as being rope holders, in some examples, the grip 124a and/or grip 124b may alternatively, or additionally, be configured as a bolt holder, wedge grip, side acting grip, manual grip, roller grip, capstan grip, and/or syringe holder. In some examples, one or both of the grips 124 may be replaced by a compression platen configured to compress the test specimen 128.

In the example of FIG. 1, the test sensor 126 is connected to the grip 124, such that the test sensor 126 can measure forces acting on the grip 124 (and/or specimen 128, crosshead 120, etc.). In some examples, the test sensor may be a load cell. In some examples, the test sensor 126 may be some other type of sensor.

In some examples, the material testing machine 102 may be configured for static mechanical testing. For example, the material testing machine 102 may be configured for compression strength testing, tension strength testing, shear strength testing, bend strength testing, deflection strength testing, tearing strength testing, peel strength testing (e.g., strength of an adhesive bond), torsional strength testing, and/or any other compressive and/or tensile testing. Additionally or alternatively, the material testing machine 102 may be configured to perform dynamic testing.

In some examples, the material testing machine 102 is configured to interface with the computing system 104 to conduct a test method. In some examples, the computing system 104 may use data imported from the data importation device(s) 108 to conduct the test method, and/or analyze results of the test method. FIG. 1 shows several examples of data importation devices 108 that might be used to import data used to conduct the test method.

In the example of FIG. 1, each data importation device 108 is a device configured to send (and/or import) data to the computing system 104. For example, the data importation device 108 may be a digital caliper 130 (e.g., configured to measure a dimension of a specimen 128, component of the material testing machine 102, etc.). As another example, the data importation device 108 may be a camera 132 (e.g., configured to capture an image of the specimen 128, component of the material testing machine 102, etc.). In some examples, the data importation device 108 may be a tag reader 134 configured to read data off a tag 136.

In some examples, a tag 136 may be attached to the specimen 128, a packaging of the specimen 128, a crosshead 120, a fixture 122 (see, e.g., FIG. 2), and/or some other component of the material testing machine 102. In some examples, the tag 136 may store information relating to the item to which the tag 136 is attached. In some examples, the tag 136 may be detached, and/or store information other than information relating to the item to which the tag 136 is attached.

In some examples, the tag 136 may be a one dimensional barcode tag 136a, a two dimensional barcode 136b (e.g., Quick Response code), a Bluetooth tag 136c (e.g., a tag 136 configured to use short-range ultra-high radio frequency in the 2.4 GHz Industrial, Scientific, and Medical (ISM) frequency band, between 2.402 and 2.480 GHz), a near field communication (NFC) tag 136d, a radio frequency identification (RFID) tag 136e, and/or some other type of tag 136. In some examples, the camera 132 may be configured to read and/or scan a one dimensional barcode tag 136a and/or two dimensional barcode tag 136b. In some examples, the camera 132 may be incorporated into the tag reader 134.

In some examples, the data importation device 108 may capture data in response to user activation of a trigger, button, or other capture input 209 of the data importation device 108 (see, e.g., FIG. 2). In some examples, the data may also be sent (and/or imported) to the computing system 104 in response to user activation of the capture input 209 of the data importation device 108 (e.g., after capture). In examples where the captured data is encoded (e.g., in a tag 136), the data importation device 108 may decode the encoded data before sending to the computing system 104, or the computing system 104 may decoded the encoded data after receiving the encoded data.

FIG. 2 is a block diagram of the material testing system 100. Similar to FIG. 1, the example of FIG. 2 shows the computing system 104 connected to the material testing machine 102 through cable 106, and the data importation device 108 connected to the computing system 104 through cord 108. FIG. 2 also shows additional details of the material testing machine 102 and computing system 104.

In the example of FIG. 2, the computing system 104 includes a computing device 202 and a user interface (UI) 204 interconnected with one another. As shown, the UI 204 may include one or more input devices 206 configured to receive inputs from a user, and one or more output devices 208 configured to provide outputs to the user. In some examples, the one or more input devices 206 may comprise one or more touch screens, mice, keyboards, buttons, switches, slides, knobs, microphones, dials, and/or other input devices 206. In some examples, the one or more output devices 208 may comprise one or more display/touch screens, speakers, lights, haptic devices, and/or other output devices 208. In some examples, the output device(s) 208 (e.g., a display screen) of the UI 204 may output one or more representations of a material testing workflow 300 configured to guide a user through setup, execution, and/or analysis of a test method conducted by the material testing machine 102.

The example material testing machine 102 includes one or more actuators 210 connected with one or more drive shafts 212. In some examples, the actuators 210 may be used to provide force to, and/or induce motion of, the drive shafts 212. In some examples, the actuators 210 may include electric motors, pneumatic actuators, hydraulic actuators, piezoelectric actuators, relays, and/or switches.

The drive shafts 212 are further shown connected to the movable crosshead 120, such that movement of the drive shaft(s) 212 via the actuator(s) 210 will result in movement of the movable crosshead 120. While termed drive shafts 212 in the example of FIG. 2, in some examples, the drive shafts 212 may be some other mechanical means of moving the movable crosshead 120 though inducement by the actuator(s) 210.

The example material testing machine 102 further includes a controller 214 in electrical communication with the actuator(s) 210. In some examples, the controller 214 may include processing circuitry and/or memory circuitry. In some examples, the controller 214 may be configured to control the material testing machine 102 based on one or more commands, control inputs, and/or test parameters. In some examples, the controller 214 may be configured to translate commands, control inputs, and/or test parameters (e.g., received from the computing system 104) to appropriate (e.g., electrical) signals that may be delivered to the actuator(s) 210, thereby controlling operation of the material testing machine 102 (e.g., via the actuator(s) 210). For example, the controller 214 may provide one or more signals(s) commanding more or less electrical power be provided to the actuator(s) 210, to thereby increase or decrease applied force.

In the example of FIG. 2, the controller 214 is further in electrical communication with the fixtures 122 (e.g., the grips 124 and test sensor(s) 126). In some examples, the controller 214 may be configured to translate commands, control inputs, and/or test parameters (e.g., received from the computing system 104) to appropriate (e.g., electrical) signals that may be delivered to the grips 124, to thereby control (e.g., grip or release) operation of the grips 124. In some examples, the controller 214 may be configured to translate commands, control inputs, and/or test parameters (e.g., received from the computing system 104) to appropriate (e.g., electrical) signals that may be delivered to the sensor(s) 126, to thereby control operation of the sensor(s) 126. In some examples, the controller 214 may be configured to translate measurement data received from the sensor(s) 126, and/or send measurement data to the computing system 104.

The example controller 214 is further in electrical communication with a control panel 216 of the material testing machine 102. In some examples, the control panel 216 may include one or more input devices (e.g., buttons, switches, slides, knobs, microphones, dials, and/or other electromechanical input devices). In some examples, the control panel 216 may be used by an operator to directly control the material testing machine 102. In some examples, the controller 214 may be configured to translate commands, control inputs, and/or test parameters received via the control panel 216 to appropriate (e.g., electrical) signals that may be delivered to the actuator(s) 210 and/or grip(s) 124 to control the material testing machine 102.

The controller 214 is also shown in electrical communication with a network interface 218b of the material testing machine 102. In some examples, the network interface 218b includes hardware, firmware, and/or software to connect the material testing machine to the computing device 104 (e.g., wirelessly and/or through cable 106). In some examples, the controller 214 may receive information (e.g., commands) from the computing device 202 through the network interface 218b, and/or send information (e.g., measurement data from sensor(s) 126) to the computing device 202 through the network interface 218b.

The example computing device 202 includes network interfaces 218a. As shown, one network interface 218a is in communication with the network interface 218b of the material testing machine 102 through cable 106. As shown, the computing device 102 further includes a network interface 218a in communication with a network 220 (e.g., the Internet). In some examples, the computing device 202 may be in communication with other computing systems 104 and/or material testing machines 102 through the network interface(s) 218a. As shown, the network interface 218b is electrically connected to a common electrical bus 220 of the computing device 202.

The computing device 202 also includes one or more input/output (I/O) interfaces 222 connected to the common electrical bus 220. In some examples, the one or more I/O interfaces 222 may comprise one or more universal serial bus (USB) ports, Thunderbolt ports, FireWire (IEEE 1394) ports, and/or any other type of serial and/or parallel data port. In some examples, the one or more I/O interfaces 222 may be configured for wireless (rather than wired) connection. As shown, the I/O interface(s) 222 are connected to the data importation device(s) 108 via cord 110.

The computing device 202 further includes processing circuitry 224 connected to the common electrical bus 220. In some examples, the processing circuitry 224 may comprise one or more processors. In some examples, the processing circuitry 224 is configured to process information received from the UI 204, data importation device(s) 108, and/or material testing machine 102. In some examples, the processing circuitry 224 is configured to transmit (e.g., via network interface(s) 218a) commands and/or test parameters to the material testing machine 102. In some examples, the processing circuitry 224 is configured to output information to an operator through the UI 204. In some examples, the computing device 202 is configured to execute machine readable instructions stored in memory circuitry 226.

The example computing device 202 further includes memory circuitry 226 connected to the common electrical bus 220. As shown, the memory circuitry 226 includes a material testing workflow 300 and a workflow progression process 400. While shown as part of the memory circuitry 226 in the example of FIG. 2, in some examples, the material testing workflow 300 and/or workflow progression process 400 may be implemented using discrete circuitry (e.g., of the processing circuitry 224).

In some examples, the material testing workflow 300 and/or workflow progression process 400 are implemented using non-transitory machine readable instructions stored in the memory circuitry 226. In some examples, the processing circuitry 224 is configured to execute the machine readable instructions of the material testing workflow 300 to guide a user through setup, execution, and analysis of a test method of the material testing machine 102. In some examples, the computing device 202 is configured to interface with the controller 214 of the material testing machine 102 to execute the test method during the material testing workflow 300.

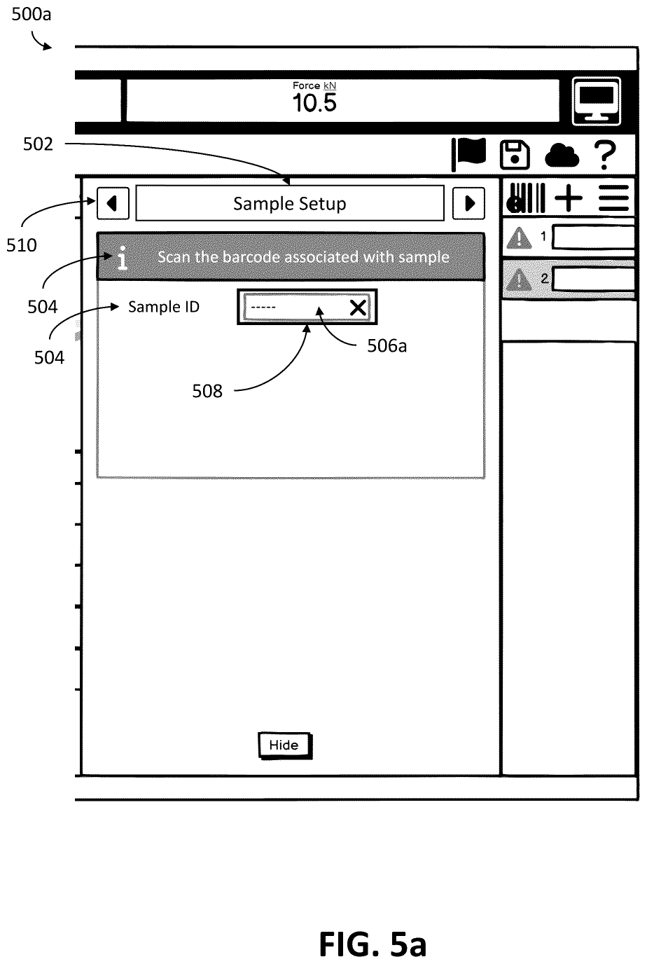

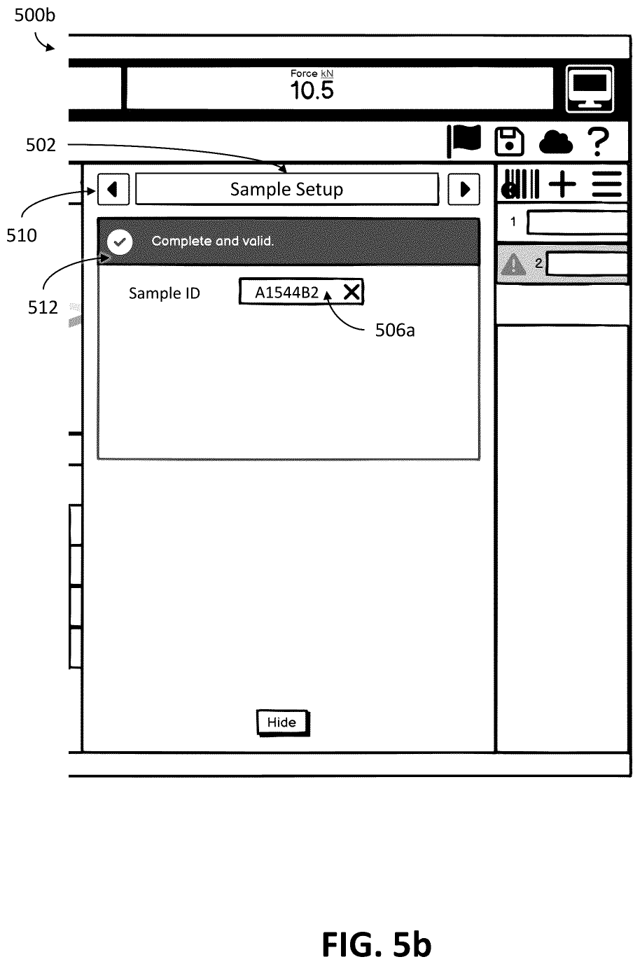

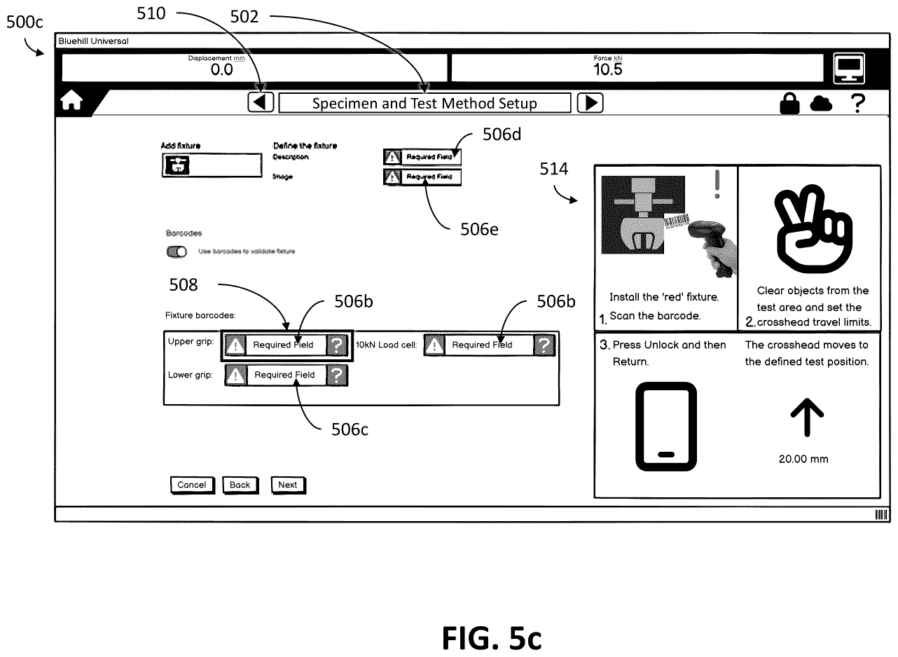

In some examples, the UI 204 is configured to show (and/or otherwise output) one or more display states of a graphical user interface (GUI) 500 (see, e.g., FIGS. 5a-5c) during execution of the material testing workflow 300. In some examples, the data importation device(s) 108 may collect (and/or import) data during (and/or used by) the material testing workflow 300, thereby reducing the potential for data entry errors. In some examples, the processing circuitry 224 is configured to execute the machine readable instructions of the workflow progression process 400 to progress through states of the material testing workflow 300 (and/or associated display states of the associated GUI 500) based on input from the data importation device(s) 108, thereby reducing the need (and/or time needed) for an operator to switch back and forth between the data importation device 108 and a separate input device 206 of the UI 204.

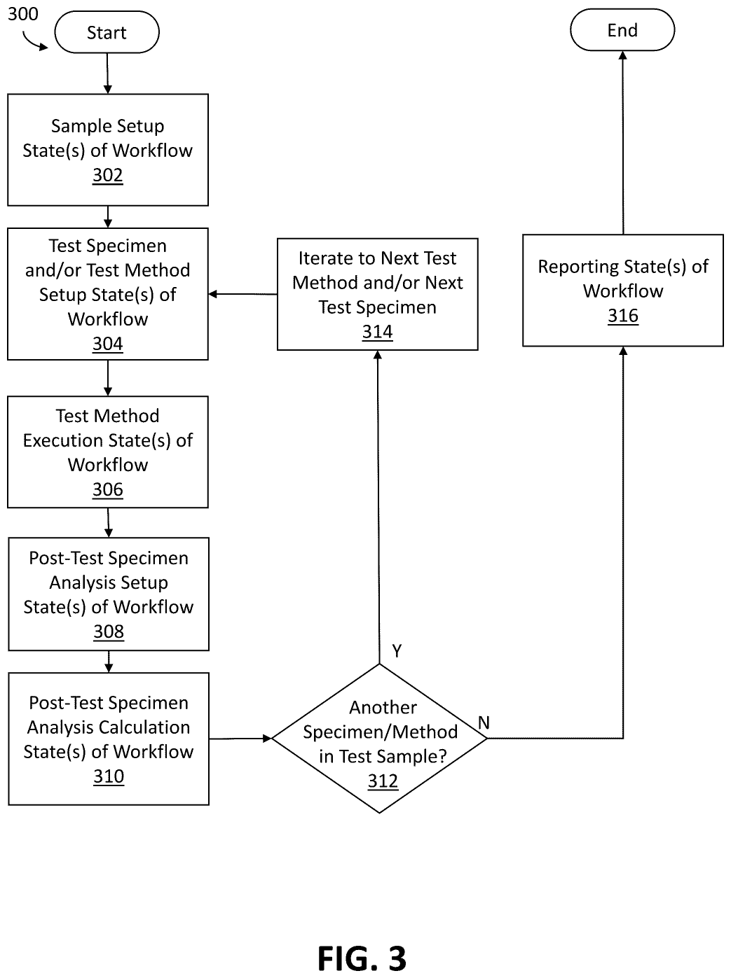

FIG. 3 is a flow diagram showing example workflow states of the material testing workflow 300. While a specific order of workflow states are shown, in some examples, the material testing workflow 300 may be customizable such that additional and/or fewer workflow states may be implemented in operation. Additionally, numerous alternative progressions through a workflow 300 may be possible.

In some examples, the material testing workflow 300 progresses through the workflow states to guide a user through setup, execution, and analysis of a test method of the material testing machine 102. In some examples, a particular workflow state may be associated with an output of the UI 204 (e.g., a display state of a GUI 500 showing one or more input fields 506, visual guidance 514, sensor measurements, test results, etc.). While the material testing workflow 300 is sometimes described below as conducting certain actions for the sake of understanding, it should be understood that one or more of the above described components of the material testing system 100 (e.g., the processing circuitry 224, UI 204, etc.) may undertake the actions on behalf (and/or according to instructions) of the material testing workflow 300.

In the example of FIG. 3, the first workflow state is a sample setup state 302 (and/or a plurality of sample setup states 302). FIGS. 5A-5C are examples of a display state of a GUI 500 that might be presented via the UI 204 during the sample setup state 302. During the example sample setup state(s) 302, the material testing workflow 300 prompts an operator for information pertaining to a set of specimens 128 of a sample, as well as information pertaining a set of test methods that will be used to test the specimens 128 of the sample.

The information prompted for (and/or collected) during the sample setup state(s) 302 may be information that is applicable to all the specimens 128 and test methods, such as, for example, a date the test(s) will be run, a date the specimens 128 were manufactured/shipped/packaged, identification information (e.g., number, name, etc.) of the operator, identification information (e.g., number(s), name(s), etc.) of the fixture(s), and/or other information relevant to all the tests of all the specimens 128. In some examples, prompted for (and/or collected) during the sample setup state(s) 302 may be imported, such as, for example, by reading a tag 136 attached to (and/or capturing an image of) a packaged sample of specimens 128, material testing machine 102, and/or component of the material testing machine 102 (e.g., fixture 122, crosshead 120, etc.). As another example, the computing device 202 may load from memory circuitry 226, or download through the network 220, information based on an image captured by the data importation device(s) 108 (e.g., an image of a packaged sample of specimens 128, material testing machine 102, and/or component of the material testing machine 102).

In the example of FIG. 3, the sample setup state 302 is followed by one or more test specimen and/or test method setup states 304. FIGS. 5A-5C show examples of a display state of a GUI 500 that might be presented via the UI 204 during the test specimen and/or test method setup state(s) 304.

During the test specimen and/or test method setup state(s) 304, the material testing workflow 300 prompts an operator for (and/or collects) information pertaining to a particular specimen 128 of a sample, and/or information pertaining a particular test method that will be used to test the particular specimen 128. For example, the information prompted for (and/or collected) during the test specimen and/or test method setup state(s) 304 may include a date the test will be run, a date the specimen 128 was manufactured/shipped/packaged, identification information of the specimen 128 (e.g., number, name, description, etc.), identification information of the test (e.g., number, name, description, etc.), pre-test characteristics of the specimen 128 (e.g., measurements, material type, weight, color, shape, etc.), target parameters of the test (e.g., start/end positions of grip(s) 124/crosshead 120, distance moved by crosshead 120, speed of movement of crosshead 120, expected result(s) of test (e.g., position/type of break, distance moved before break, force applied before break, post-test characteristics of sample, etc.), time(s) when sensor(s) 126 should take measurement(s), etc.), and/or other information relevant to a particular test method and/or a particular specimen.

In some examples, information prompted for (and/or collected) during the test specimen and/or test method setup state(s) 304 may be imported. For example, the data importation device(s) 108 may import information read from a tag 136 attached to a specimen 128 (and/or associated packaging), material testing machine 102, and/or component of the material testing machine 102 (e.g., fixture 122, crosshead 120, etc.). As another example, the data importation device(s) 108 may import information regarding the specimen 128 measured by a digital caliper 130. As another example, the computing device 202 may load from memory circuitry 226, or download through the network 220, information relating to the specimen 128 based on an image captured by the data importation device(s) 108.

In the example of FIG. 3, the test specimen and/or test method setup state 304 is followed by a test method execution state 306 (and/or test method execution states 306). During the test method execution state(s) 306, the computing device 202 communicates with the material testing machine 102 (e.g., via network interfaces 218) to execute the test method on the test specimen 128 using the material testing machine 102 according to the information received during the test specimen and/or test method setup state(s) 304 and/or sample setup state(s) 302. For example, the processing circuitry 224 of the computing device 202 may determine and/or send one or more parameters and/or commands to the material testing machine 102, and the controller 214 of the material testing machine 102 may control the actuator(s) 210 of the material testing machine 102 to execute the test method in accordance with the command(s) and/or parameter(s).

In the example of FIG. 3, the test method execution state 306 is followed by one or more post-test analysis setup states 308. During the post-test analysis setup state(s) 308, the material testing workflow 300 prompts an operator for (and/or collects) information pertaining to an analysis of the test method that was executed during the test method execution state 306.

For example, the information prompted for (and/or collected) during the post-test specimen analysis setup state(s) 308 may include post-test characteristics of the specimen 128, actual parameters of the test, actual results of the test, and/or other information relevant to an analysis of the test method and/or test sample. While shown as a separate state in FIG. 3, in some examples, the post-test specimen analysis setup state(s) 308 may be integrated into the test specimen and/or test method setup state(s) 304.

In the example of FIG. 3, the one or more post-test specimen analysis setup states 308 are followed by one or more post-test specimen analysis calculation states 310 of the material testing workflow 300. During the post-test specimen analysis calculation state(s) 310, the processing circuitry 224 of the computing device 202 may perform one or more calculations based on the information collected during the previous post-test specimen analysis setup state(s) 308. For example, the processing circuitry 224 may estimate a strength, reliability, quality, grade, resiliency, and/or other characteristic of the specimen 128. As another example, the processing circuitry 224 may hypothesize about the structure and/or composition of the specimen 128. As another example, the processing circuitry may hypothesize about the future performance of the specimen 128.

In the example of FIG. 3, the material testing workflow 300 repeats states 304-310 for all the test methods and/or test specimens of the test sample (setup at state 302). As shown, after state 310, the material testing workflow 300 iterates to the next test method and/or test specimen at state 314 (provided there is another test method or test specimen), then returns to state 304. Once states 304-310 have been completed for all the test methods and/or test specimens of the test sample, the material testing workflow 300 moves through one or more reporting state(s) 316, where the material testing workflow 300 may provide reports on the results of the test sample according to operator specifications.

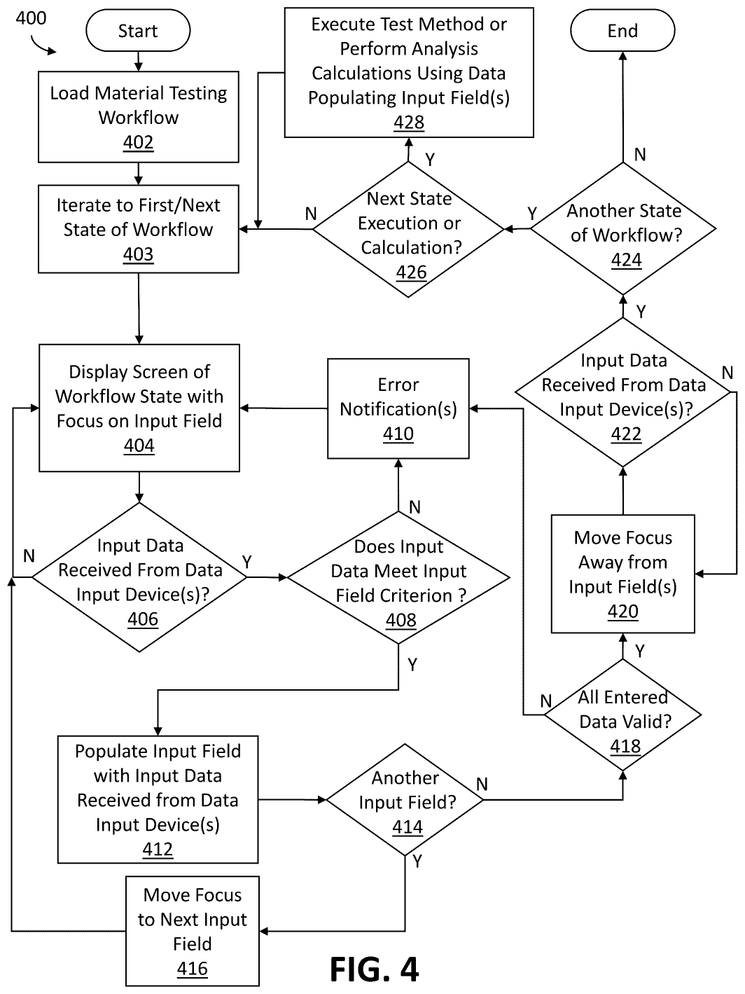

FIG. 4 is a flow diagram depicting an example operation of the workflow progression process 400 of the computing device 202. In some examples, the workflow progression process 400 may allow an operator to automatically import information using the data importation device(s) 108 (reducing data entry errors). The workflow progression process 400 may additionally enable the operator to progress from one state of the material testing workflow 300 to another using the same data importation device(s) 108, thereby reducing the inconvenience of (and/or time needed for) switching back and forth between the data importation device(s) 108 and UI 204 of the computing system 104. While the workflow progression process 400 is sometimes described below as conducting certain actions for the sake of understanding, it should be understood that one or more of the above described components of the material testing system 100 (e.g., the processing circuitry 224, UI 204, etc.) may undertake the actions on behalf (and/or according to instructions) of the workflow progression process 400.

In the example of FIG. 4, the workflow progression process 400 begins at block 402, where the material testing workflow 300 is loaded from memory circuitry 226 of the computing device 202 (e.g., via processing circuitry 224). In some examples, the operator may use the UI 204 of the computing system 104 to select the appropriate material testing workflow 300 be loaded. In some examples, the material testing workflow 300 may be loaded from an external device and/or through the network 220.

In the example of FIG. 4, after block 402, the workflow progression process 400 proceeds to block 403, where the workflow progression process 400 progresses the material testing workflow 300 to its first state (e.g., the sample setup state 302 shown in FIG. 3). Afterwards, at block 404, the workflow progression process 400 outputs one or more prompts 504 and/or input fields 506 associated with the first state of the material testing workflow 300 (e.g., via UI 204). For example, the one or more prompts 504 and/or input fields 506 may be outputted as part of a display screen and/or GUI (e.g., one of the GUIs 500 shown in FIGS. 5A-5C).

In some examples, the one or more prompts 504 output at block 404 prompt a user to enter into the input field(s) 506 certain information relevant to the current state of the material testing workflow 300. In some examples, the workflow progression process 400 additionally focuses on a particular input field 506 of the one or more input fields 506. In some examples, the input field 506 that has the focus for input will be the input field 506 that is populated with data in response to input of data by the operator through the UI 204, and/or importation of data through the data importation device 108. In some examples, guidance 514 may additionally be output that instructs the operator how to use the data importation device 108 to input data (see, e.g., FIG. 5c).

FIG. 5a is an example of a GUI 500 that might be shown (e.g., via a display screen of the UI 204) during a sample setup state 302 of the material testing workflow 300 (e.g., at block 404). As shown, the GUI 500 includes a state identifier 502 that identifies the state of the material testing workflow 300 to which the GUI 500 corresponds. The GUI 500 also includes input prompts 504a prompting a user to enter information regarding a test sample into an input field 506a. While the input field 506a is shown filled with dots as placeholders until input is received, in some examples, the input field 506a may instead be blank and/or unfilled until input is received. As shown, the input field 506a is surrounded by a focus highlight 508 to emphasize that the input field 506a has the focus for input.

In the example of FIG. 4, after block 404, the workflow progression process 400 proceeds to block 406, where the workflow progression process 400 checks whether input data has been received from the data importation device(s) 108. As previously discussed, the data importation device(s) 108 may send (or import) data to the computing device 202 in response to activation of a capture input 209 of the data importation device(s) 108. As shown, the workflow progression process 400 returns to block 404 if no data is received from the data importation device 108.

In the example of FIG. 4, after block 406, the workflow progression process 400 proceeds to block 408 if data is received from the data importation device 108. At block 408, the workflow progression process 400 determines whether the received data complies with one or more input criterion associated with the input field 506. In some examples, one or more input criterion may be associated with an input field 506 during setup and/or customization of the material testing workflow 300. In some examples, the one or more criterion may define certain conditions that the input data must meet in order for the input data to be acceptable for population of the input field 506.

For example, the input field criterion may mandate that any received data intended for the input field 506 be in a particular format (e.g., as a date, number, alphanumeric string, single character, Boolean value, etc.). As another example, the input field criterion may mandate that any received data intended for the input field 506 be associated with a particular type of fixture 122, sample, or specimen 128. For example, the memory circuitry 226 may store (and/or the computing device 202 may access via network 220) a data structure that associates certain identifying information with certain types (e.g., classifications, categories, makes, models, brands, etc.) of fixtures 122, samples, and/or specimens 128, and the workflow progression process 400 determine whether the fixture 122, sample, and/or specimen 128 associated with the received data is of a type that is in compliance with the input field criterion. As part of the determination at block 408, the workflow progression process 400 may translate and/or decode the data received from the data importation device(s) 108 if necessary.

In the example of FIG. 4, after block 408, the workflow progression process 400 proceeds to block 410 if the received data does not comply with one or more input criterion associated with the input field 506. At block 410, one or more error notifications (e.g., similar to the success notification 512 discussed below) are output (e.g., via the UI 204). In some examples, the error notification(s) may inform the operator that the received input did not meet one or more input criterion, and/or give an explanation as to why the input was deficient and/or how the deficiency might be remedied. As shown, the workflow progression process 400 returns to block 404 after block 410.

In the example of FIG. 4, after block 408, the workflow progression process 400 proceeds to block 412 if the received data does comply with the one or more input criterion associated with the input field 506. At block 410, the received data is used to populate the input field 506. Afterwards, the workflow progression process 400 determines (at block 414) whether there is another input field 506 (e.g., yet to be populated) that is associated with the current state of the material testing workflow 300. If so, the workflow progression process 400 moves the focus for input (and/or focus highlight 508) to the next input field at block 416, and then returns to block 404.

In the example of FIG. 4, after block 414, the workflow progression process 400 proceeds to block 418 when all the input fields have been populated. At block 418, the workflow progression process 400 determines whether the input field data of (e.g., all of) the input field(s) 506 comply with one or more state criterion associated with the current state of the material testing workflow 300. Like the input criterion of block 408, in some examples, state criterion may be associated with the current state of the material testing workflow 300 during setup and/or customization of the material testing workflow 300. In some examples, the state criterion may define certain conditions that the input data must meet in order for the input data to be acceptable for collection during the current state of the material testing workflow 300.

For example, the state criterion may mandate that a fixture 122 (e.g., identified during the current state) is appropriate for use with an identified material testing machine 102 and/or specimen 128 (e.g., also identified during the current state). As another example, the state criterion may mandate that a specimen 128 to be tested using an identified fixture 122 and/or material testing machine 102 be within certain size and/or weight limits, and/or be of an appropriate type. In some examples, a data structure may be used to make the determination (e.g., similar to that which is discussed above with respect to block 408). As shown, the workflow progression process 400 proceeds to block 410 after block 418 if it is determined that the data does not comply with the one or more state criterion associated with the current state of the material testing workflow 300.

In the example of FIG. 4, after block 418, the workflow progression process 400 proceeds to block 420 if it is determined that the data does comply with the one or more state criterion associated with the current state of the material testing workflow 300. At block 420, the focus for input (and/or focus highlight 508) is moved away from the input field(s) 506 associated with the current state of the material testing workflow 300. In some examples, the focus for input (and/or focus highlight 508) is moved to a selectable button, icon, or other element (e.g., of the GUI 500). For example, the focus for input (and/or focus highlight 508) may be moved to an arrow element 510 (see, e.g., FIGS. 5a-5c). In some examples, the focus for input (and/or focus highlight 508) may be removed entirely, such that no field, element, or other item (e.g., in the GUI 500) has the focus for input (and/or focus highlight 508). In some examples, a success notification 512 may additionally be output to inform the operator that the state criterion check at block 418 was successful (see, e.g., FIG. 5b).

In the example of FIG. 4, after block 420, the workflow progression process 400 proceeds to block 422, where the workflow progression process 400 again checks whether input data has been received from the data importation device(s) 108 (e.g., similar to block 406). In some examples, guidance 514 may be output at blocks 420-422 (and/or blocks 406-408) that instructs the operator how to use the data importation device 108.

In the example of FIG. 4, after block 422, the workflow progression process 400 proceeds to block 424 when input data is received from the data importation device(s) 108. In some examples, the actual data received from the data importation device(s) 108 at block 422 may be irrelevant, and/or discarded. As long as some data is received (e.g., indicating activation of the capture input 209), the workflow progression process 400 proceeds to block 424. In some examples, the data collected during the current state of the material testing workflow 300 (e.g., at block 412) may be saved to the memory circuitry 226 after (or prior to) proceeding to block 424.

In the example of FIG. 4, the workflow progression process 400 checks whether there is an additional (as yet unexecuted) state of the material testing workflow 300 at block 424. If not, the workflow progression process 400 ends. If so, the workflow progression process 400 checks (at block 426) whether the next state is an execution or calculation state (e.g., test method execution state 306 or post-test specimen analysis calculation state 310).

If the next state is an execution or calculation state, then the workflow progression process 400 proceeds to block 428, where the material testing workflow 300 progresses to (and/or executes/calculates) the execution or calculation state. In some examples, the data collected during prior states of the material testing workflow 300 may be used to perform the executions and/or calculations of the execution/calculation state(s). If the next state is not an execution or calculation state, the workflow progression process 400 proceeds to block 403 after block 426 (and also proceeds to block 403 after block 426), where the workflow progression process 400 iterates to the next state in the material testing workflow 300, and then starts again at block 404.

FIGS. 5a-5c show examples of a GUI 500 (e.g., output by the UI 204) that changes what is displayed (e.g., its display state) as an associated material testing workflow 300 progresses from one state to a next (e.g., in response to input from a data importation device 108). In FIG. 5a, the GUI 500 includes a state identifier 502 that identifies the state of the material testing workflow 300 (to which the display state of the GUI 500 corresponds) as a sample setup state 302. As shown, the GUI 500 includes prompts 504 (e.g., such as might be shown during block 404 of the workflow progression process 400) that direct an operator to enter a sample ID into a sample ID input field 506a. The sample ID input field 506a is also surrounded by a focus highlight 508 indicating that the sample ID input field 506a has the focus for input.

FIG. 5b shows the GUI 500 after data has been entered into the sample ID input field 506a (e.g., via importation from the data importation device(s) 108 at block 412). As shown, the state identifier 502 in FIG. 5a is the same as in FIG. 5b, indicating that the display state of the GUI 500 (and/or the state of the material testing workflow 300) has not changed. A success notification 512 is also shown indicating that the data imported into the sample ID input field 506a has successfully passed the input field criterion and/or state criterion check(s) (e.g., at blocks 408 and/or 418). However, the focus highlight 508 is not longer shown, indicating that the focus for input has been moved away from the input field(s) 506 (e.g., at block 420).

FIG. 5c shows the GUI 500 after additional input has been received (e.g., via importation from the data importation device(s) 108 at block 422), thereby progressing the material testing workflow 300 (and/or GUI 500) to a new state. As shown, the GUI 500 in FIG. 5c looks significantly different than the GUI 500 shown in FIG. 5b, as befitting a different display state. Additionally, different input fields 506 are shown in the GUI 500. As shown, the focus highlight 508 now surrounds an upper grip input field 506b. The state identifier 502 in the GUI 500 of FIG. 5c also identifies a different state than that which is identified in FIGS. 5a-5b, indicating that the material testing workflow 300 (and/or GUI 500) has progressed to a new state (e.g., in response to importation of data from data importation device(s) 108 at block 422).

The disclosed material testing system 100 allows operators to use data importation devices 108 to automatically import data into input fields 506 of a GUI 500 associated with a material testing workflow 300. Such automatic importation helps to avoid potential errors in manual entry. Additionally, the material testing system 100 allows operators to advance the material testing workflow 300 (and/or GUI 500) from one state to another, thereby reducing the need (and/or time needed) for an operator to switch back and forth between the data importation device(s) 108 and a separate input device of the UI 204.

The present methods and/or systems may be realized in hardware, software, or a combination of hardware and software. The present methods and/or systems may be realized in a centralized fashion in at least one computing system, or in a distributed fashion where different elements are spread across several interconnected computing or cloud systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

As used herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

As utilized herein, the terms “e.g.,” and “for example” set off lists of one or more non-limiting examples, instances, or illustrations.

As used herein, the terms “coupled,” “coupled to,” and “coupled with,” each mean a structural and/or electrical connection, whether attached, affixed, connected, joined, fastened, linked, and/or otherwise secured. As used herein, the term “attach” means to affix, couple, connect, join, fasten, link, and/or otherwise secure. As used herein, the term “connect” means to attach, affix, couple, join, fasten, link, and/or otherwise secure.

As used herein the terms “circuits” and “circuitry” refer to physical electronic components (i.e., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, circuitry is “operable” and/or “configured” to perform a function whenever the circuitry comprises the necessary hardware and/or code (if any is necessary) to perform the function, regardless of whether performance of the function is disabled or enabled (e.g., by a user-configurable setting, factory trim, etc.).

As used herein, a control circuit may include digital and/or analog circuitry, discrete and/or integrated circuitry, microprocessors, DSPs, etc., software, hardware and/or firmware, located on one or more boards, that form part or all of a controller, and/or are used to control a welding process, and/or a device such as a power source or wire feeder.

As used herein, the term “processor” means processing devices, apparatus, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general purpose microprocessor or microcontroller, a digital signal processing (DSP) processor, an application-specific integrated circuit (ASIC), a graphic processing unit (GPU), a reduced instruction set computer (RISC) processor with an advanced RISC machine (ARM) core, etc. The processor may be coupled to, and/or integrated with a memory device.

As used, herein, the term “memory” and/or “memory device” means computer hardware or circuitry to store information for use by a processor and/or other digital device. The memory and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like. Memory can include, for example, a non-transitory memory, a non-transitory processor readable medium, a non-transitory computer readable medium, non-volatile memory, dynamic RAM (DRAM), volatile memory, ferroelectric RAM (FRAM), first-in-first-out (FIFO) memory, last-in-first-out (LIFO) memory, stack memory, non-volatile RAM (NVRAM), static RAM (SRAM), a cache, a buffer, a semiconductor memory, a magnetic memory, an optical memory, a flash memory, a flash card, a compact flash card, memory cards, secure digital memory cards, a microcard, a minicard, an expansion card, a smart card, a memory stick, a multimedia card, a picture card, flash storage, a subscriber identity module (SIM) card, a hard drive (HDD), a solid state drive (SSD), etc. The memory can be configured to store code, instructions, applications, software, firmware and/or data, and may be external, internal, or both with respect to the processor.

What is claimed is:

1. A material testing system, comprising:
a data importation device, the data importation device comprising a camera, a tag reader, or a measurement device;
a material testing machine, comprising:
a test sensor, a test actuator, and a test controller configured to control the test actuator;
a display screen; and
a computing device configured for communication with the display screen, the material testing machine, and the data importation device, the computing device comprising:
processing circuitry configured to:
initiate a material testing workflow configured to guide a user through setup, execution, or analysis of a test method of the material testing machine,
display, on the display screen, a first graphical user interface (GUI) associated with a first state of the material testing workflow, the first GUI comprising one or more input fields,
in response to receiving final field input data from the data importation device while a final input field of the one or more input fields has a focus for input: populate the final input field using the final field input data, and advance the focus for input away from the one or more input fields, and
in response to receiving subsequent input data from the data importation device after the one or more input fields are populated on the display screen and the focus for input has been advanced away from the one or more input fields: advance the material testing workflow from the first state to a second state, and display, on the display screen, a second GUI associated with the second state of the material testing workflow.

2. The system of claim 1, wherein the processing circuity of the computing device is further configured to control the controller of the material testing machine to execute the test method using the final field input data.

3. The system of claim 1, wherein the tag reader comprises a barcode reader, a near field communication (NFC) tag reader, a radio frequency identification (RFID) tag reader, or a short range ultra-high radio frequency tag reader.

4. The system of claim 1, wherein the measurement device comprises a digital caliper.

5. The system of claim 1, wherein the first GUI further comprises guidance regarding how to use the data importation device to obtain the final field input data or subsequent input data.

6. The system of claim 1, wherein the processing circuitry is further configured to:
validate that the final field input data meets an input criterion, and
prevent population of the final input field, advancement of the focus for input, or execution of the test method if the final field input data does not meet the test criterion.

7. The system of claim 6, wherein validating that the final field input data meets the input criterion comprises validating that the final field input data is representative of an identifier of a fixture that complies with a test configuration of the test method.

8. A method, comprising:
initiating, via processing circuitry of a computing device, a material testing workflow configured to guide a user through setup, execution, or analysis of a test method of a material testing machine in communication with the computing device, the material testing machine comprising a test sensor, a test actuator, and a test controller configured to control the test actuator;
displaying, on a display screen in communication with the computing device, a first graphical user interface (GUI) associated with a first state of the material testing workflow, the first GUI comprising one or more input fields;
receiving, at the computing device, final field input data from a data importation device while a final field input field of the one or more input fields has a focus for input, the data importation device comprising a camera, a tag reader, or a measurement device;
in response to receiving, at the computing device, the final field input data from the data importation device while the final input field of the one or more input fields has the focus for input:
populating the final input field using the final field input data, and
advancing the focus for input away from the one or more input fields; and
in response to receiving subsequent input data at the computing device, from the data importation device, after the one or more input fields are populated on the display screen and the focus for input has been advanced away from the one or more input fields:
advancing the material testing workflow from the first state to a second state, and
displaying, on the display screen, a second GUI associated with the second state of the material testing workflow.

9. The method of claim 8, further comprising controlling, by the processing circuitry of the computing device, the controller of the material testing machine to execute the test method using the final field input data.

10. The method of claim 8, wherein the tag reader comprises a barcode reader, a near field communication (NFC) tag reader, a radio frequency identification (RFID) tag reader, or a short range ultra-high radio frequency tag reader.

11. The method of claim 8, wherein the measurement device comprises a digital caliper.

12. The method of claim 8, wherein the first GUI further comprises guidance regarding how to use the data importation device to obtain the final field input data or subsequent input data.

13. The method of claim 8, further comprising:
validating, by the processing circuitry, that the final field input data meets an input criterion; and
preventing population of the final input field, advancement of the focus for input, or execution of the test method if the final field input data does not meet the test criterion.

14. The method of claim 13, wherein validating that the final field input data meets the input criterion comprises validating that the final field input data is representative of an identifier of a fixture that complies with a test configuration of the test method.

15. A non-transitory computer readable medium comprising machine readable instructions which, when executed by a processor, cause the processor to:
initiating a material testing workflow configured to guide a user through setup, execution, or analysis of a test method of a material testing machine, the material testing machine comprising a test sensor, a test actuator, and a test controller configured to control the test actuator;
display, on a display screen, a first graphical user interface (GUI) associated with a first state of the material testing workflow, the first GUI comprising one or more input fields;
receive final field input data from a data importation device while a final field input field of the one or more input fields has a focus for input, the data importation device comprising a camera, a tag reader, or a measurement device;
in response to receiving the final field input data from the data importation device while the final input field of the one or more input fields has the focus for input:
populate the final input field using the final field input data, and
advance the focus for input away from the one or more input fields; and
in response to receiving subsequent input data at the computing device, from the data importation device, after the one or more input fields are populated on the display screen and the focus for input has been advanced away from the one or more input fields:
advance the material testing workflow from the first state to a second state, and
display, on the display screen, a second GUI associated with the second state of the material testing workflow.

16. The non-transitory computer readable medium of claim 15, further comprising machine readable instructions which, when executed by a processor, cause the processor to: control the controller of the material testing machine to execute the test method using the final field input data.

17. The non-transitory computer readable medium of claim 15, wherein the tag reader comprises a barcode reader, a near field communication (NFC) tag reader, a radio frequency identification (RFID) tag reader, or a short range ultra-high radio frequency tag reader, and wherein the measurement device comprises a digital caliper.

18. The non-transitory computer readable medium of claim 15, wherein the first GUI further comprises guidance regarding how to use the data importation device to obtain the final field input data or subsequent input data.

19. The non-transitory computer readable medium of claim 15, further comprising machine readable instructions which, when executed by a processor, cause the processor to:
validate that the final field input data meets an input criterion; and
prevent population of the final input field, advancement of the focus for input, or execution of the test method if the final field input data does not meet the test criterion.

20. The non-transitory computer readable medium of claim 19, wherein validating that the final field input data meets the input criterion comprises validating that the final field input data is representative of an identifier of a fixture that complies with a test configuration of the test method.
